(19) United States
(12) Patent Application Publication
(10) Pub. No.: US 2011/0200291 A1
(43) Pub. Date: Aug. 18, 2011

(54) CABLE WITH MULTIPLE JACKETS AND TRANSITION ELEMENTS AND ASSEMBLIES THEREFOR

(76) Inventors: Eric R. Logan, Hickory, NC (US); Michael H. Rasmussen, Keller, TX (US); Todd R. Rhyne, Hickory, NC (US)

(21) Appl. No.: 13/093,229

(22) Filed: Apr. 25, 2011

Related U.S. Application Data
(63) Continuation of application No. PCT/US09/62468, filed on Oct. 29, 2009.
(60) Provisional application No. 61/110,311, filed on Oct. 31, 2008.

(51) Int. Cl. G02B 6/44; B23P 11/00

(52) U.S. Cl. 385/103; 29/428

(57) ABSTRACT

A ruggedized cable has an inner and an outer jacket. The cable also includes two layers of aramid strength elements for tensile strength. The cable can be pulled through various environments due to the jacketing and strength elements. The outer jacket and strength elements can be stripped away at a transition point, and secured at an entry point of a housing of an FDT, ONT, etc. The remaining inner cable element is then routed through the hardware housing and terminated.

### RELATED APPLICATIONS

This application is a continuation of International Application PCT/US2009/062468, filed Oct. 29, 2009, which claims the benefit of U.S. Provisional App. No. 61/110,311, filed Oct. 31, 2008, the entire contents of which are incorporated by reference as if presented herein.

### TECHNICAL FIELD

The present application relates to rugged drop cables.

### BACKGROUND

Bend-insensitive optical fibers provide greater flexibility and ease of installation than standard single- and multi-mode fiber cables incorporating conventional optical fibers. While the conveyed optical signal itself suffers little or no attenuation over tight bends, the optical fibers are subject to tensile, bending, and crush stresses, etc.

Rugged drop cable designs have been utilized to protect bend-insensitive fibers and optical fibers in general. One conventional rugged drop cable has a tightly buffered optical fiber surrounded by aramid fibers (for tensile strength), and a heavy, fire retardant polymer jacket. Such cables are installed using standard techniques and may be subjected to tensile loads of 50 pounds (220 Newtons) or more. Such high tensile loads can cause the aramid fibers to break free from the cable jacket, which may cause the jacket to elongate elastically. During elongation of the cable jacket, the strength elements and the optical fiber may remain at their original lengths. A length difference ΔL therefore exists between the strength elements/fiber and the elongated jacket. When the tensile load is removed and the cable jacket returns to its original length, ΔL does not change, and the strength elements and optical fiber are compressively deformed, causing a phenomenon known as “wavy fiber.” Wavy fiber can be generally described as severe sinusoidal or serpentine bending of one or more optical fibers within the cable jacket.

Phenomena such as wavy fiber can be mitigated by further ruggedization of the drop cable, such as by the use of thicker cable jackets and heavier strength elements. Each additional protective element, however, increases cost, adds bulk to the cable, and may increase the difficulty in processing the fiber, e.g. connectorizing.

### SUMMARY

According to one embodiment of the present invention, a cable comprises an inner cable having an inner jacket of a first diameter, and an outer jacket surrounding the inner cable and having a second diameter. One or more layers of strength elements may also be included adjacent to the jackets.

According to one aspect of the embodiment, the dual jackets and strength element layers provide ruggedness for installation, so that the cable can be pulled through relatively problematic environments. The outer jacket can be removed to expose the inner cable, which can be pulled through smaller, confined spaces, such as within a connection enclosure. The inner cable can also be sized so that it can be connectorized using existing parts and procedures within the connection enclosure. The cable therefore provides the installer with the installation advantages of heavier cables outside of a connection enclosure, and the routing and connectorization advantages of smaller cables inside the enclosure.

According to another aspect, transition elements can be placed at the point of transition from the larger diameter cable to the inner cable. The transition elements can be used for strain relief and for securing the cable to a fixed assembly such as a connection enclosure.

According to yet another aspect of the embodiment, cable is sufficiently rugged so as to mitigate or eliminate the effects of wavy fiber.

It is to be understood that both the foregoing general description and the following detailed description present embodiments of the invention, and are intended to provide an overview or framework for understanding the nature and character of the invention as it is claimed.

### BRIEF DESCRIPTION OF THE DRAWINGS

FIG. 1 is a cross section a cable according to a first embodiment.

FIG. 2 illustrates an end of the cable shown in FIG. 1.

FIGS. 3-5 illustrate stripping the end of the cable shown in FIG. 1 and the application of transition elements.

FIG. 6 illustrates an alternative transition element.

FIG. 7 illustrates another alternative transition element.

FIG. 8 illustrates yet another alternative transition element.

FIG. 9 shows an alternative method of securing the end of the cable.

FIGS. 10 and 11 illustrate the effects of tensile loading on the cable.

FIG. 12 illustrates a cable assembly including the cable of FIG. 1.

### DETAILED DESCRIPTION

Reference will now be made in detail to the present embodiments, examples of which are illustrated in the accompanying drawings. When practical, the same or similar reference numerals are used throughout the drawings to refer to the same or like parts.

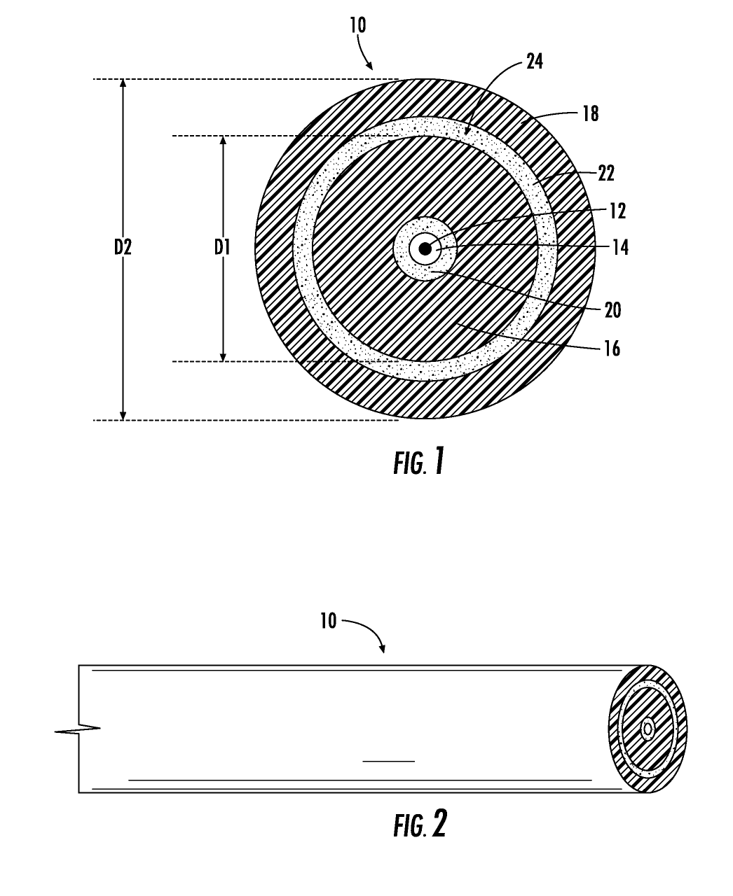

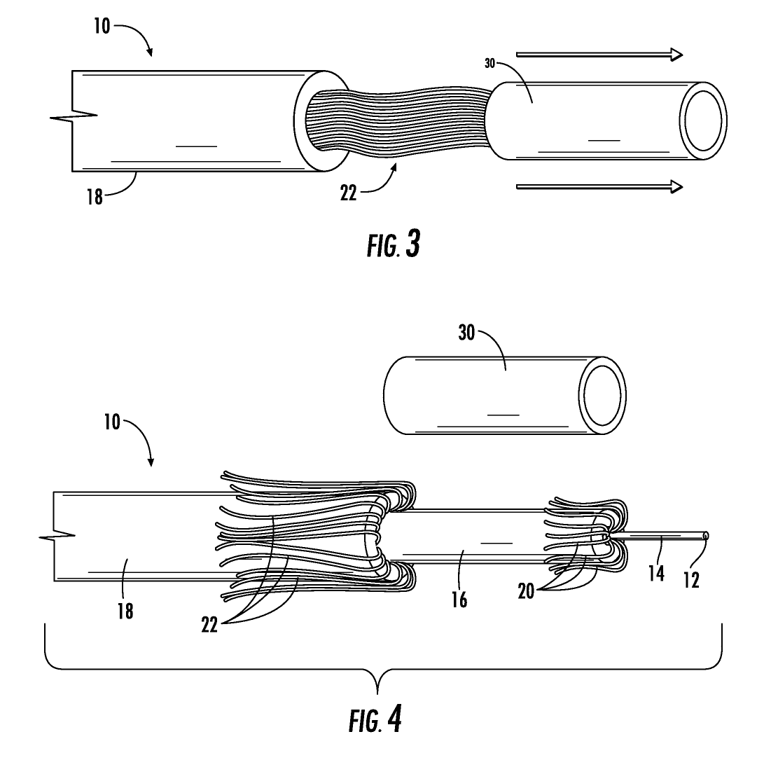

FIG. 1 is a cross section of a cable 10 according to a first embodiment. FIG. 2 illustrates an end of the cable 10. Referring to FIGS. 1 and 2, the cable 10 has at least one optical fiber 12, a tight buffer layer 14 surrounding the optical fiber 12, an inner jacket 16 surrounding the tight buffer layer 14, and an outer jacket 18 surrounding the inner jacket 16. An inner strength element layer 20 can be disposed between the tight buffer layer 14 and the inner jacket 16, and an outer strength element layer 22 can be disposed between the inner jacket 16 and the outer jacket 18. The dual jackets and dual strength element layers provide the cable 10 with the necessary ruggedness for ease of installation, and the versatility to be routed in confined spaces, while also being capable of termination using existing parts and methods.

The optical fiber 12 can be, for example, a bend-insensitive optical fiber, such as fibers sold under the name ClearCurve™, available from Corning Incorporated. Other bend-insensitive fibers and conventional optical fibers can also be used. The inner jacket 16 and the outer jacket 18 can be polymeric and can include materials, such as, for example, flame-retardant polymers conforming to NEC® OFNR and CSA OFN FT-4 for riser rated cables. The terms “polymer” and “polymeric” as used in this specification allow for the presence of additives, such as are commonly used in flame-rated jacket materials.

Any suitable jacket material may be used for the inner jacket 16 and the outer jacket 18, such as, for example, polyurethanes (PU), polyvinylchloride (PVC), polyethylenes (PE), polyproplyenes (PP), UV-curable materials, and other polymer materials. The inner strength element layer 20 and the outer strength element layer 22 provide tensile strength to the cable 10. The strength element layers 20, 22 can be comprised of high tensile strength fibers aligned generally along the length of the cable 10. The fibers can be aramid or para-aramid synthetic fibers such as, for example, KEVLAR™, though other suitable materials may include fiberglass, polyester, high tensile polypropylene, and the like. The use of a layer of discrete tensile fibers provides tensile strength to the cable while also providing high flexibility for the cable 10. The outer strength element layer 22 can be arranged so that some of the tensile fibers in the layer 22 contact the exterior of the inner jacket 16 and so that some of the tensile fibers contact the interior of the outer jacket 18.

Optical fibers used in the present embodiments may be coated with the tubular tight buffer layer 14, which can be polymeric. In the illustrated example, a single optical fiber 12 is a bend-insensitive ClearCurve™ fiber capable of bending to a 5 mm radius without appreciable attenuation, and the tight buffer layer 14 is a 900 μm thick layer of flame-retardant PVC material. Other buffer layer thicknesses, such as 500 μm are also possible. The inner strength element layer 20 can be arranged so that some of the tensile fibers in the layer 20 contact the tight buffer layer 14 and so that some of the fibers contact the interior of the inner jacket 16.

As shown in FIG. 1, the cable 10, and accordingly the outer jacket 18, have an average or optimal diameter D2. The inner jacket 16, inner strength element layer 20, and the buffered optical fiber 12 form an inner cable 24 having an average or optimal outside diameter D1 that is smaller than D2. The diameters D1 and D2 should be considered average diameters for the illustrated cross-section because some ovality and other defects may occur in manufacturing that cause the jackets to be non-circular to some degree. The diameter D1 may be, for example, 80% or less of the diameter D2. In the illustrated embodiment, the diameter D1 is 70% or less of the diameter D2.

To manufacture the cable 10, the tight-buffered optical fiber 12 is paid out through a non-stranded layer of tensile aramid yarn fibers that form the inner strength element layer 20. Flame-retardant polymer material is then pressure-extruded over the inner strength element layer 20 to form the inner jacket 16. The inner jacket 16, inner strength element layer 20, and the buffered optical fiber 12 form the inner cable 24. In the exemplary embodiment, the nominal diameter D1 is 2.9 mm. The land length of the extrusion die used to extrude the polymer material for the inner jacket 16 is controlled to achieve a reasonable bonding force of the aramid yarns of the inner strength element layer 20 to the inner jacket 16. Bonding force can be determined by measuring the force required to remove a 10 inch section of the inner jacket 16 from the inner strength element layer 20. According to one embodiment, the force can be in the range of 5 to 15 lbs (22-66 Newtons). The 2.9 mm diameter inner cable 24 is paid out through a helically stranded layer of tensile fibers to form the outer strength element layer 22. In the illustrated embodiment, the fibers are aramid yarns of KEVLAR™. The inner drop cable 24 with helically stranded outer strength element layer 22 may then be passed through an applicator where a layer of mineral particulates (such as talc) is applied. The polymer outer jacket 18 is then extruded over the outer strength element layer 22. In the exemplary embodiment, the outer jacket 18 has an outer diameter D2 of 4.8 mm. The amount of mineral particulates applied and the amount of pressure in the extrusion die can be controlled to provide a moderate stripping force of the outer jacket 18 from the outer strength element layer 22. The stripping force can be in the range of 5 to 40 lbs (22-178 Newtons) for the removal of a 10 inch section of outer jacket 18.

FIG. 2 shows an end 28 of the cable 10 ready for processing steps such as connectorization and/or optical coupling to another fiber, either within the factory or in the field. According to the present invention, the dual jackets 16, 18 and dual strength element layers 20, 22 provide the cable 10 with the necessary ruggedness for installation in relatively harsh conditions. The inner cable 24 can be separated from the exterior remainder of the cable 10 by stripping away an end portion of the outer jacket 18 and layer 22. The exposed portion of the inner cable 24 may then be routed through smaller, relatively confined spaces, where the additional ruggedness of the jacket 18 and layer 22 may not be required. Further, the inner cable 24 can be configured for connectorization using known parts and procedures, and is suitable for interface housings for multiple dwelling units (MDU). For example, the reduced diameter inner cable 24 can be installed in a housing, such as an Optisheath® MDU Terminal available from Corning Cable Systems, LLC. The ruggedness of the cable 10 also mitigates or eliminates the effects of wavy fiber in the cable 10. The cable therefore provides the installer with the installation advantages of heavier cables and the routing, connectorization, and other processing advantages of smaller cables. An exemplary method of processing the cable 10 is described below with reference to FIGS. 3-5.

FIG. 3 shows an end portion 30 of the outer jacket 18 stripped away intact. The end portion 30 can be stripped away using a ring cut, using a commercially available wire stripper. A length of 24 inches to 48 inches of the end of the outer jacket 18 may be removed. Mineral particulate applied on the outer strength element layer 22 and the controlled extrusion of the outer jacket 18 can be selected to obtain a desired coupling strength. The coupling strength, or, the force required to pull the outer jacket 18 off of the inner jacket 16 and the outer strength element layer 22 can be selected so that is it less than the force required to elastically deform the inner jacket 16. Elastic deformation of the inner jacket 16 may have the adverse effect of decoupling the bond between the inner layer of strength elements 20 and the inner jacket 16.

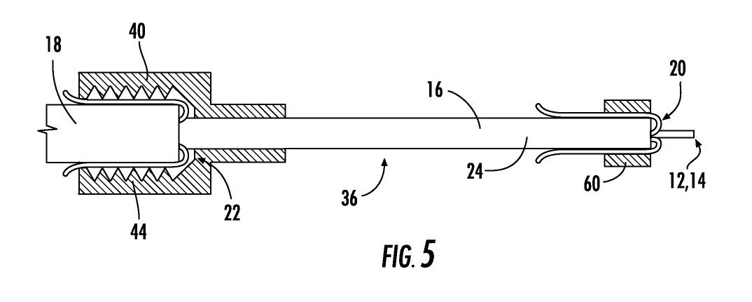

Referring to FIG. 4, after removal of the end portion 30 of the outer jacket 18, an end portion (not shown) of the inner jacket 16 is removed in the same manner as the end portion 30 to expose a sufficient length of tightly buffered layer 14 and fiber 12. The tensile strength fibers of the inner and outer strength element layers 20, 22 can be trimmed and laid back along the respective inner and outer jackets, 16 and 18, as shown in FIG. 4.

Referring to FIG. 5, prior to connectorizing the cable 10, one or more transition elements can be secured to the furcated end 36 of the cable. The transition elements, which include an outer transition element 40 and an inner transition element 60 in the illustrated embodiment, can be included for strain relief. Strain relief can be advantageous at locations such as at the point where the cable 10 enters an MDU and is abruptly of reduced diameter. The exemplary outer transition element 40 is a machined metallic piece with an interior threaded bore 44. The threaded bore 44 can be threaded over the laid back fibers of the outer strength element layer 22 and the outer jacket 18 so that it is firmly secured to the jacket 18. Similarly, the inner transition element 60 can be a crimp ring tightened around the laid back fibers of the inner strength element layer 20 and the inner jacket 16 so that it is secured to the jacket 16. In the exemplary embodiment, the outer transition element 40 transitions the cable 10 from the 4.8 mm diameter outer jacket 18 to the 2.9 diameter inner jacket 16. The inner transition element 60 can be part of the connectorization of the inner cable 24 of 2.9 mm diameter inner jacket 16 with a connector (shown in FIG. 12).

With the transition elements attached, the fiber 12 can now be optically connected to a connector, such as connecting to a pigtailed connector, or, for directly connectorizing to a standard connector such as an SC connector, or to a field installable connector such as UniCam™ SC, ST and LC available from Corning Cable Systems, LLC. Connectorization can take place, for example, in a connection enclosure.

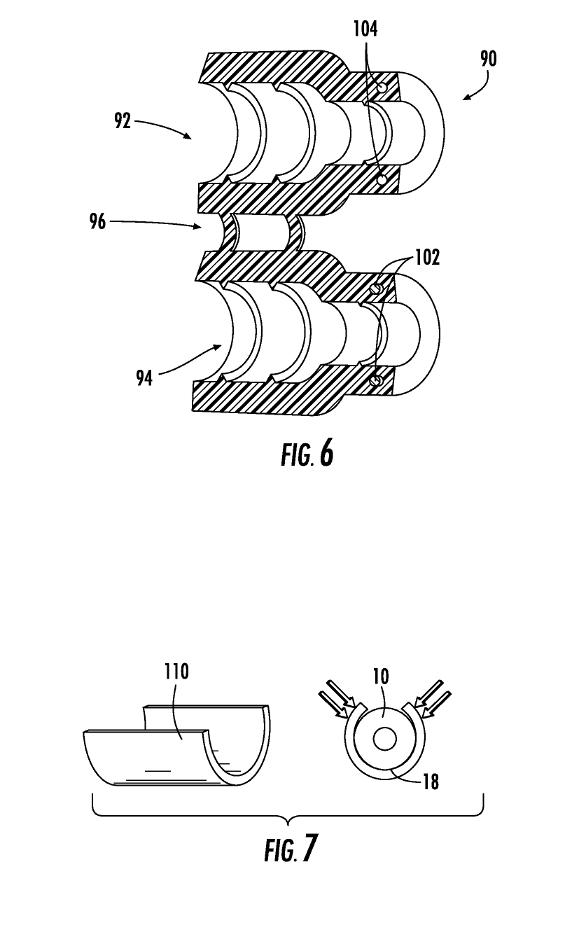

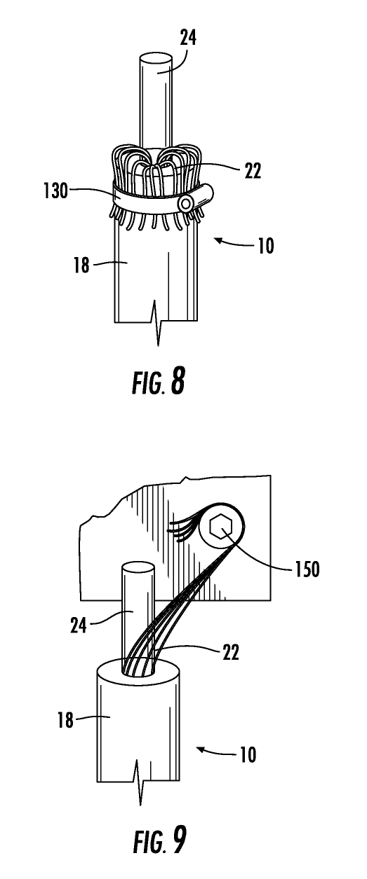

FIGS. 6-9 illustrate alternative configurations and arrangements for the outer transition element. FIG. 6 illustrates an outer transition element 90 in the form of plastic clip-on piece. Referring also to FIG. 4, opposing sections 92, 94 of the transition element 90 can be crimped over the tensile fibers of the outer strength element layer 22 and over the outer jacket 18. The opposing halves 92, 94 fold about a living hinge 96 and attach to one another through engagement of projections 102 with apertures 104. FIG. 7 illustrates an outer transition element 110 in the form of a metallic U-clip. Referring also to FIG. 4, the transition element 110 can be crimped over the tensile fibers of the outer strength element layer 22 and over the outer jacket 18. FIG. 8 illustrates an outer transition element 130 in the form of a cable tie. Referring also to FIG. 4, the transition element 130 can be tightened around the tensile fibers of the outer strength element layer 22 and over the outer jacket 18.

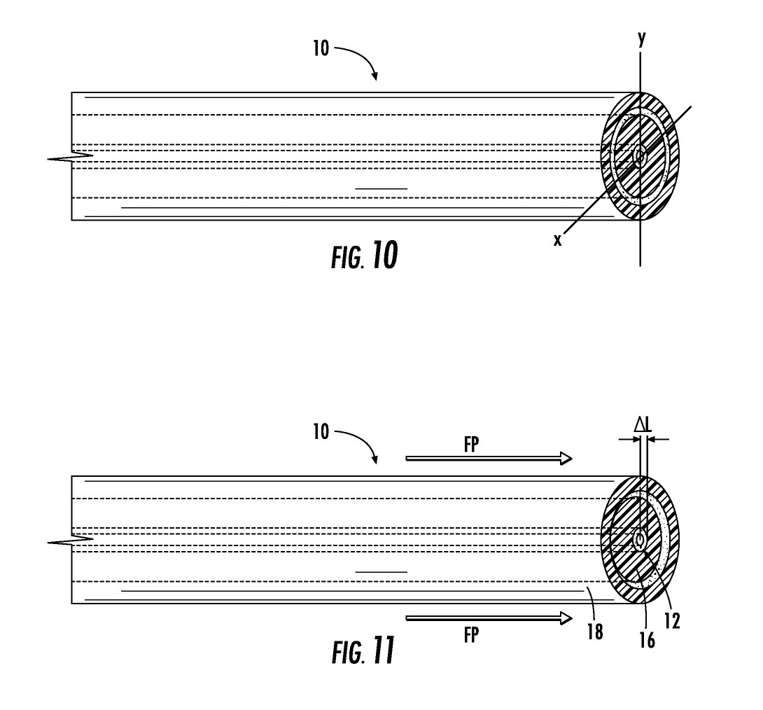

As an alternative to securing the tensile fibers of the outer strength element layer 22 to the outer jacket 18, the fibers can be secured to an exterior element. FIG. 9, for example, illustrates the tensile fibers of the outer strength element 22 secured under a screw terminal 150.

### Example

A cable 10 as illustrated in FIGS. 1-2 is installed to optically connect a fiber connection enclosure such as a fiber distribution terminal (FDT) to an apartment unit in an MDU. The cable 10 is pulled between the FDT and an apartment unit using conventional means. The cable 10 is prepared for connectorization as shown in FIGS. 3-5. The FDT can be of conventional design, having a housing enclosing hardware, and an entry point through which cables are connected to the FDT. At the entry point, the outer transition element is secured to a holding device (e.g., a crimp holder) at the entry point to the FDT. Any of the transition elements disclosed in this specification are suitable for securing the cable at the entry point. The smaller diameter inner cable 24 is then routed through the interior of the FDT. The inner cable 24 is terminated using an OptiSnap™ connector using crimp bands.

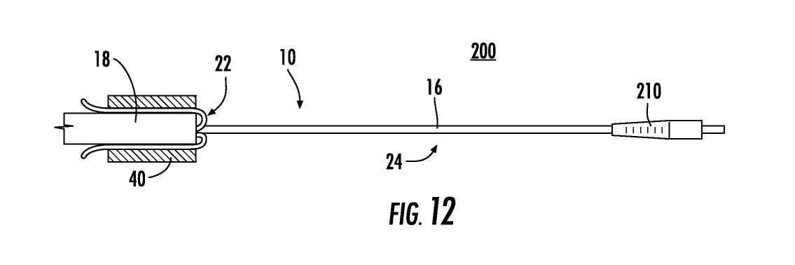

FIGS. 10-11 illustrate the resistance of the cable 10 to the wavy fiber phenomenon. FIG. 10 illustrates the cable 10 ready for installation, such as for pulling through ductwork, etc., when installing the cable 10 in a structure. A holding device such as a pressure clamp or a Kellum's grip can be used to securely couple to the outer jacket 18, which enables the installer to exert the necessary force to pull the cable 10 through narrow openings or ducts. The presence of dual jackets 16, 18 and strength element layers 20, 22 provides high tensile strength and durability to the cable 10 during such installations. Initially, the cut end face of the cable 10 is substantially flush in the plane defined by axes x and y. Referring to FIG. 11, as the cable 10 is subjected to tensile pulling forces FP during installation, the elastic outer jacket 18 generally does not transfer excessive tensile loads to the inner jacket 16. The outer jacket 18 may therefore elongate and extend past the inner jacket 16 and the optical fiber 12 by a distance ΔL. According to one aspect, when the outer jacket 18 retracts to its original length, little or none of the compressive load is transmitted to the inner jacket 16, thereby inhibiting or precluding the creation of wavy fiber in the cable 10. In other words, the outer jacket 18 bears most or all of the positive and negative tensile loads of installation such that fiber(s) in the inner cable 24 is not subject to the wavy fiber phenomenon. The limited space within the cable jacket also inhibits buckling of the fiber 12.

FIG. 12 illustrates the cable 10 of FIG. 1 as part of a cable assembly 200. The cable assembly 200 has an SC connector assembly 210 connected at the end of the cable 10.

Many modifications and other embodiments of the present invention, within the scope of the claims will be apparent to those skilled in the art. For instance, the concepts of the present invention can be used with any suitable composite cable designs and/or optical stub fitting assemblies. Thus, it is intended that this invention covers these modifications and embodiments as well those also apparent to those skilled in the art.

We claim:

1. A fiber optic cable, comprising:
at least one optical fiber;
a first layer of strength elements surrounding the at least one optical fiber;
a first jacket surrounding the first layer of strength elements;
a second layer of strength elements surrounding the first jacket; and
a second jacket surrounding the second layer of strength elements.

2. The fiber optic cable of claim 1, wherein the at least optical fiber is a tight buffered fiber.

3. The fiber optic cable of claim 1, wherein the strength elements are longitudinally extending fibers.

4. The fiber optic cable of claim 3, wherein an outside diameter of the second jacket is less than 5 millimeters.

5. The fiber optic cable of claim 4, wherein an outside diameter of the first jacket is less than 3 millimeters.

6. The fiber optic cable of claim 3, wherein an outside diameter of the first jacket is eighty percent or less of an outside diameter of the second jacket.

7. The fiber optic cable of claim 3, wherein an outside diameter of the first jacket is seventy percent or less of an outside diameter of the second jacket.

8. The fiber optic cable of claim 3, wherein the first jacket is an extruded polymeric tube and the second jacket is an extruded polymeric tube.

9. The fiber optic cable of claim 5, wherein the at least one optical fiber contacts the first layer of strength elements, the first layer of strength elements contacts an interior of the first jacket, an exterior of the first jacket contacts the second layer of strength elements, and the second layer of strength elements contacts an interior of the second jacket.

10. The fiber optic cable of claim 9, wherein the at least one optical fiber comprises a tight buffer layer.

11. A method of connectorizing a fiber optic cable, comprising:
providing a fiber optic cable having at least one optical fiber; a first jacket surrounding the at least one optical fiber, the at least one optical fiber and first jacket comprising an inner cable; and a second jacket surrounding the inner cable;
running the cable so that an end of the cable is at a connection enclosure;
removing an end portion of the second jacket to expose an end portion of the inner cable;
routing the end portion of the inner cable through the connection terminal;
removing an end portion of the first jacket to expose an end portion of the at least one optical fiber; and
connectorizing the end portion of the at least one optical fiber.

12. The method of claim 11, further comprising attaching a transition element to the fiber optic cable at a transition point where the end portion of the second jacket is removed.

13. The method of claim 11, wherein the inner cable further comprises a first layer of strength elements between the at least one optical fiber and the first jacket.

14. The method of claim 13, wherein the fiber optic cable further comprises a second layer of strength elements between the inner cable and the second jacket.

15. The method of claim 14, wherein the at least one optical fiber contacts the first layer of strength elements, the first layer of strength elements contacts an interior of the first jacket, an exterior of the first jacket contacts the second layer of strength elements, and the second layer of strength elements contacts an interior of the second jacket.

16. The method of claim 13 wherein the optical fiber is a tight buffered fiber.

17. The method of claim 13, wherein the strength elements are fibers.

18. The method of claim 11, wherein the first jacket has a nominal diameter of about 2.9 mm and the second jacket has a nominal diameter of about 4.8 mm.

19. The method of claim 11, further comprising attaching an outer transition element on the second jacket adjacent to where the end portion of the second jacket is removed.

20. The method of claim 19, further comprising securing the cable to the connection enclosure where the end portion of the second jacket is removed.

21. The method of claim 20, further comprising attaching an inner transition element on the first jacket adjacent to where the end portion of the first jacket is removed.

22. The method of claim 19, wherein the first jacket is an extruded polymeric tube and the second jacket is an extruded polymeric tube.

23. A fiber optic cable, comprising:
a tight-buffered optical fiber;
a first layer of aramid strength fibers surrounding the at least one optical fiber;
a polymeric tubular first jacket surrounding and contacting the first layer of aramid strength fibers;
a second layer of aramid strength fibers surrounding the polymeric first jacket; and
a polymeric tubular second jacket surrounding the second layer of aramid strength fibers, wherein
an outside diameter of the second jacket is less than 5 millimeters, and
an outside diameter of the first jacket is less than 3 millimeters.
